(19) United States
(12) Patent Application Publication
(10) Pub. No.: US 2004/0100883 A1
(43) Pub. Date: May 27, 2004

(54) Information recording/reproducing apparatus and information recording medium

(76) Inventor: Koubun Sakagami, Kanagawa (JP)

Correspondence Address: DICKSTEIN SHAPIRO MORIN & OSHINSKY LLP, 2101 L STREET NW, WASHINGTON, DC, 20037-1526, US

(21) Appl. No.: 10/700,524

(22) Filed: Nov. 5, 2003

(30) Foreign Application Priority Data
Nov. 21, 2002 (JP) 2002-338342

(51) Int. Cl. G11B 7/00

(52) U.S. Cl. 369/47.35; 369/59.11; 369/53.35

(57) ABSTRACT

An information recording/reproducing apparatus, which includes a binary/multi-level data converting unit converting binary data into multi-level data, a test data generating unit generating test data forming part of the multi-level data, a data recording unit recording the multi-level data including the test data to an information recording medium, a signal reproducing unit outputting reproduction signals of the multi-level data including the test data from the information recording medium, a test data examining unit examining the reproduction signals of the multi-level data including the test data to determine whether the test data is normal, a waveform equalization unit equalizing a waveform of the examined test data when the test data examining unit determines that the test data is normal, and a multi-level determining unit determining multi-level data by referring to a pattern table generated using the examined test data.

### BACKGROUND OF THE INVENTION

1. Field of the Invention

The present invention relates to an information recording/reproducing apparatus and an information recording medium, and more particularly to an information recording/reproducing apparatus and an information recording medium using test data, which is employed to be read beforehand, when reproducing multi-level data.

2. Description of the Related Art

As a conventional technology, Japanese Patent Laid-Open Application No. 8-124167, for example, discloses an optical recording medium and an optical disk apparatus for recording and reproducing multi-level data. With this technology, sizes of recording marks are converted into two or more kinds of sizes corresponding to multi-level data, and are then recorded to predetermined grid points on an optical recording medium by irradiating laser light thereto. The recording medium has an area for allowing an amount of information leaking-in from a grid point, which is disposed two-dimensionally nearest to a grid point targeted for reproduction, to be detected therefrom. A group of the recording marks are recorded to grid points in the aforementioned recording medium area. Based on detected values previously obtained by scanning the group of recording marks with a spot of light, an amount of cross-talk from an adjacent track, and an amount of inter-symbol interference between adjacent grids are acquired beforehand. Accordingly, cross-talk between adjacent tracks is reduced by using signals during reproduction of information. Furthermore, information leak in from two-dimensionally adjacent grid points can be reduced to thereby reduce inter-symbol interference with respect to a track targeted for reproduction.

As another conventional technology, Japanese Patent Laid-Open Application No. 2002-260345 (same applicant as that for the present invention), for example, discloses a method which detects multi-level data by pattern recognition. In a case where laser light is irradiated on an optical disk having information disposed proximal to each other, inter-symbol interference is thereby caused when plural marks are included inside the spot on which the laser light is irradiated during reproduction of signals. This method supposes that the inter-symbol interference is correlative and executes pattern recognition for detecting (obtaining) multi-level data. More specifically, this method employs a table for pattern recognition, in which the table is created by previously reproducing test data for every combination of 3 consecutive data (points). When detecting the multilevel data, 3 consecutive data (points) are inputted to thereby search for a pattern that is closest to the patterns in the table. The pattern obtained from the search is determined as a resultant multi-level data.

As another conventional technology, Japanese Patent Application No. 2002-123008, for example, discloses a data format for recording and reproducing multi-level data with the foregoing method of detecting multi-level recording data, in which test data is added into a prescribed amount of user data to thereby record onto an information recording medium.

With the technology described in Japanese Patent Laid-Open Application No. 8-124167, for example, the information recording medium, to which multi-level data is recorded, has data areas (referred to as “equalization coefficient learning areas”) formed thereon at prescribed intervals. When reading information from recording marks formed on the information recording medium by irradiating a laser light thereto, a waveform equalization filter is employed for removing cross-talk from adjacent tracks and inter-symbol interference from adjacent data allocated on a same track. The equalization coefficient learning areas have test data (calibration data) recorded thereto for determining equalization coefficient.

The foregoing conventional technologies, however, share a common problem of being unable to properly reproduce test data and detect multi-level data when there is a defect such as a scratch or a stain formed at a portion of the information recording medium on which the test data is recorded.

### SUMMARY OF THE INVENTION

It is a general object of the present invention to provide an information recording/reproducing apparatus and an information recording medium that substantially obviates one or more of the problems caused by the limitations and/or disadvantages of the related art. More particularly, it is an object of the present invention to provide an information recording/reproducing apparatus and an information recording medium that is able to precisely detect multi-level data even in a case where there is a defect such as a scratch or a stain formed on a portion of an information recording medium at which test data is recorded.

Features and advantages of the present invention will be set forth in the description which follows, and in part will become apparent from the description and the accompanying drawings, or may be learned by practice of the invention according to the teachings provided in the description. Objects as well as other features and advantages of the present invention will be realized and attained by a data processing apparatus, a data processing method, and a data processing program particularly pointed out in the specification in such full, clear, concise, and exact terms as to enable a person having ordinary skill in the art to practice the invention.

To achieve these and other advantages and in accordance with the purpose of the invention, as embodied and broadly described herein, the invention provides an information recording/reproducing apparatus, including: a binary/multi-level data converting unit converting binary data into multi-level data; a test data generating unit generating test data forming part of the multi-level data; a data recording unit recording the multi-level data including the test data to an information recording medium; a signal reproducing unit outputting reproduction signals of the multi-level data including the test data from the information recording medium; a test data examining unit examining the reproduction signals of the multi-level data including the test data to determine whether the test data is normal; a waveform equalization unit equalizing a waveform of the examined test data when the test data examining unit determines that the test data is normal; and a multi-level determining unit determining multi-level data by referring to a pattern table generated using the examined test data.

One of the features of the present invention is that the information recording/reproducing apparatus according to the present invention includes a test data examining unit. The test data examining unit distinguishes test data inside a frame, computes distribution of the test data, and determines whether the test data is normal by determining whether a feature amount is a prescribed value. In a case where there is a defect (e.g. stain, scratch) on a portion of an information recording medium at which test data is recorded, the test data could not heretofore be reproduced normally, and multi-level data could not heretofore be detected precisely. With the present invention, however, the test data examining unit can determine whether or not the test data is normal. Therefore, abnormal test data caused by defects on the information recording medium can be eliminated, and multi-level data can be detected precisely.

In the information recording/reproducing apparatus of the present invention, the test data examining unit may include: a data distinguishing unit categorizing an input data frame into a test frame including the test data and a data frame; a distribution computing unit computing a frequency distribution of values for the reproduction signals of the test data; a feature amount detection unit detecting a feature amount of the computed frequency distribution; a comparing unit deciding whether the test data is normal by comparing the detected feature amount with a prescribed value; and a memory unit storing the values of the reproduction signals of the test data. Furthermore, in the information recording/reproducing apparatus of the present invention, when the data distinguishing unit determines that the input data frame is the test frame, the waveform equalizing unit and the multi-level determining unit stop operating, the distribution computing unit starts computing the frequency distribution of the values for the reproduction signals of the test data, and the memory unit stores the test data. Another feature of the present invention is that the test data examining unit distinguishes (categorizes) input frame data into a test frame and a data frame, activates (initiates) the distribution computing unit when distinguishes that the input frame data is the test frame, determines whether the test frame is normal by referring to a feature amount of the test frame, and if the test data is determined to be normal, the test data is output as effective data.

With the present invention, operation of the waveform equalizing unit and the multi-level data determining unit is stopped only when the input data is distinguished to be test data. Therefore, mistakenly performing waveform equalization and determination of multi-level data can be prevented.

In the information recording/reproducing apparatus of the present invention, when the comparing unit decides that the test data is normal, effective data in the memory unit is output to the waveform equalization unit for determining a coefficient of a filter of the waveform equalization unit according to automatic equalization algorithm, and the effective data is also output to the multi-level data determining unit for generating the pattern table.

The comparing unit in the test data examining unit serves to decide (determine) whether the test data is normal. If the comparing unit decides that the test data is normal, effective data stored in the memory is output to the waveform equalizing unit at which filter coefficient for waveform equalization is determined according to automatic equalization algorithm. Thus, at the same time, data is output to the multi-level data determining unit at which a pattern table for pattern recognition is generated.

With the present invention, waveform equalization according to the effective data stored in the memory and generation of the pattern table of multilevel data is only performed only when the test data is determined to be normal. Therefore, waveform equalization and output of multi-level data can be performed precisely.

In the information recording/reproducing apparatus of the present invention, the multi-level data determining unit may include: a pattern table generating unit generating the pattern table; and a multi-level data detecting unit detecting the multi-level data by searching through the pattern table for a pattern which is similar to effective data in the memory unit. Furthermore, in the information recording/reproducing apparatus of the present invention, when the test data examining unit determines that the test data is normal, the multi-level data detecting unit outputs the effective data in the memory unit as multi-level data.

The pattern table generating unit included in the multi-level data determining unit may generate a table for pattern recognition by, for example, reproducing test data with every combination of 3 consecutive multi-level data (points) recorded thereto. The multi-level data detection unit may search through the pattern table for a pattern which is similar to effective data in the memory unit, to thereby output a similar effective data.

With the present invention, precise effective data can be reliably output since the effective data is determined according to the pattern table generated from the test data.

In the information recording/reproducing apparatus of the present invention, when the comparing unit decides that the test data is abnormal, the test data from the information recording medium may be examined again and input to the distribution computing unit.

Test data on the information recording medium (optical disk) may, at times, be read out (examined) in a manner being adversely affected from contingent noise. Therefore, in a case of inputting data into the distribution computing unit, the reading out (examining) of the test data may be performed more than once, so that test data being adversely affected from contingent noise can be eliminated.

In the information recording/reproducing apparatus of the present invention, the test data may not used when the test data is again decided to be abnormal. If the test data is decided to be abnormal after examining the test data again, the optical disk, on which the abnormal test data is recorded, is likely to have a critical defect. Therefore, the abnormal test data serves no benefit and should preferably be eliminated. With the present invention, the optical disk is considered to have a critical defect formed thereto when the test data determined to be abnormal after examining (reading out) the test data again. By not using (eliminating) the abnormal test data, multilevel data detection can be performed precisely.

In the information recording/reproducing apparatus of the present invention, one or more test data from the information recording medium may be examined, wherein when the feature amount of the test data surpasses a prescribed range, the value of the reproduction signals of the test data surpassing the prescribed range may be excluded, wherein an average of the values of the reproduction signals of the test data except for the excluded test data may be obtained for detecting the multi-level data.

As one example, 10 test frames may be examined; abnormal test frames may then be eliminated from the 10 test frames; an average of the values of the reproduction signals of the remaining test frames may be obtained; a waveform equalization coefficient may be determined according to the obtained average; and a pattern table may be generated. Subsequently, data frames (900 frames) allocated between the 10 test frames may be processed.

With the present invention, since an average of the values of the reproduction signals of the test data are used (excluding abnormal test frames), error of multi-level detection can be reduced when the reproduction signals of the entire disk are stable.

In another example, 2 test frames may be examined; an average of the values of the reproduction signals of the 2 test frames may be obtained; a waveform equalization coefficient may be determined according to the obtained average; and a pattern table may be generated. Subsequently, data frames allocated between the 2 test frames may be processed. This example is effective where changes of reproduction signals vary according to the location of the optical disk. With the present invention, since an average of the values of the 2 normal reproduction signals of the test data are used, error of multi-level detection can be reduced when changes of reproduction signals vary according to the location of the optical disk.

In the information recording/reproducing apparatus of the present invention, the test data is allocated before and after the multi-level data.

Recording conditions (e.g. amount of laser light) are relatively uniform when data is re-written or written once on a same disk with a same information recording/reproducing apparatus (optical disk apparatus), and thus changes in reproduction signals are relatively small. Meanwhile, reproduction signals may change rather considerably where data is re-written or written once on a same disk with a different information recording/reproducing apparatus (optical disk apparatus). Therefore, it is preferable to dispose test frames in front of and in back of the data frame. This enables more adaptability to changes of reproduction signals owing to the characteristics of each information recording/reproducing apparatus, and reduces multi-level data detection errors.

In the information recording/reproducing apparatus of the present invention, the test data may include combinations of data comprising same numeric series. More amounts of data may be included in 1 frame, and plural test data of same series may be included in the test frame so that even in a case where there is an abnormality in one of the series of test data, another series of test data may be employed, to thereby enhance the reliability of data.

In the information recording/reproducing apparatus of the present invention, the test data may include combinations of data comprising different numeric series. Although the above described case is a case where plural test data of same series are included in a single frame, plural test data of different series may also be included in a single frame. This increases the randomness of the test data. By using the average value of the plural test data of different series, signals can be further restrained from changing. Although the above described embodiment is a case where data is processed by reading 1 test frame each time, the same test frame may be read for several times so as to process data by using the average value of the test frames. Accordingly, random changes owing to factors such as noise can be reduced, to thereby reduce multilevel detection errors.

Furthermore, the present invention provides an information recording/reproducing apparatus for reproducing multi-level data based on examined test data, wherein multi-level data is converted from binary data, test data is generated as part of multi-level data, and reproduction signals of the multi-level data including the test data are reproduced as reproduction signals including the test data, the information recording/reproducing apparatus including: a test data examining unit examining the reproduction signals of the multi-level data including the test data to determine whether the test data is normal; a waveform equalization unit equalizing a waveform of the examined test data when the test data examining unit determines that the test data is normal; and a multi-level determining unit determining multi-level data including the examined test data by referring to a pattern table.

Furthermore, the present invention provides an information recording medium including: multi-level data converted from binary data; and test data used in reproducing the multi-level data, wherein the test data includes combinations of data comprising same numeric series. Accordingly, even in a case where there is an abnormality in one of the series of test data, another series of test data may be employed, to thereby enhance the reliability of data.

Furthermore, the present invention provides an information recording medium including: multi-level data converted from binary data; and test data used in reproducing the multi-level data, wherein the test data includes combinations of data comprising different numeric series. By including plural test data of different series in a single frame, randomness of the test data can be increased. By using the average value of the plural test data of different series, signals can be further restrained from changing.

Other objects and further features of the present invention will be apparent from the following detailed description when read in conjunction with the accompanying drawings.

### BRIEF DESCRIPTION OF THE DRAWINGS

FIG. 1 is a block diagram showing an information recording/reproducing apparatus according to an embodiment of the present invention;

FIG. 2 is a diagram showing an internal structure of a multi-level converting circuit 9 according to an embodiment of the present invention;

FIG. 3 is a diagram showing three examples of test data according to an embodiment of the present invention;

FIG. 4 is a diagram showing an example of a data format for allocating test data and effective data according to an embodiment of the present invention;

FIG. 5 is a diagram showing an example of reproducing a reproduction signal in a case where a clock mark 25, a synchronization signal 26, and distinction data 27 (when the data is a test frame) are recorded to an optical disk 1 according to an embodiment of the present invention;

FIG. 6 is a diagram showing a structure of a test data examining circuit 17 according to an embodiment of the present invention;

FIG. 7 is a diagram showing an example of a distribution of signals of test data according to an embodiment of the present invention;

FIG. 8 is a diagram showing another example of a distribution of signals of test data according to an embodiment of the present invention;

FIG. 9 is a diagram showing an internal structure of a multi-level judging circuit 14 according to an embodiment of the present invention;

FIG. 10 is a diagram showing an example of a distribution of signals of test data in a case where the test data is normal;

FIG. 11 is a diagram showing an example of a distribution of signals of test data in a case where the test data is abnormal; and

FIG. 12 is a diagram showing an allocation of frame data according to an embodiment of the present invention.

### DESCRIPTION OF THE PREFERRED EMBODIMENTS

In the following, embodiments of the present invention will be described in detail with reference to the accompanying drawings.

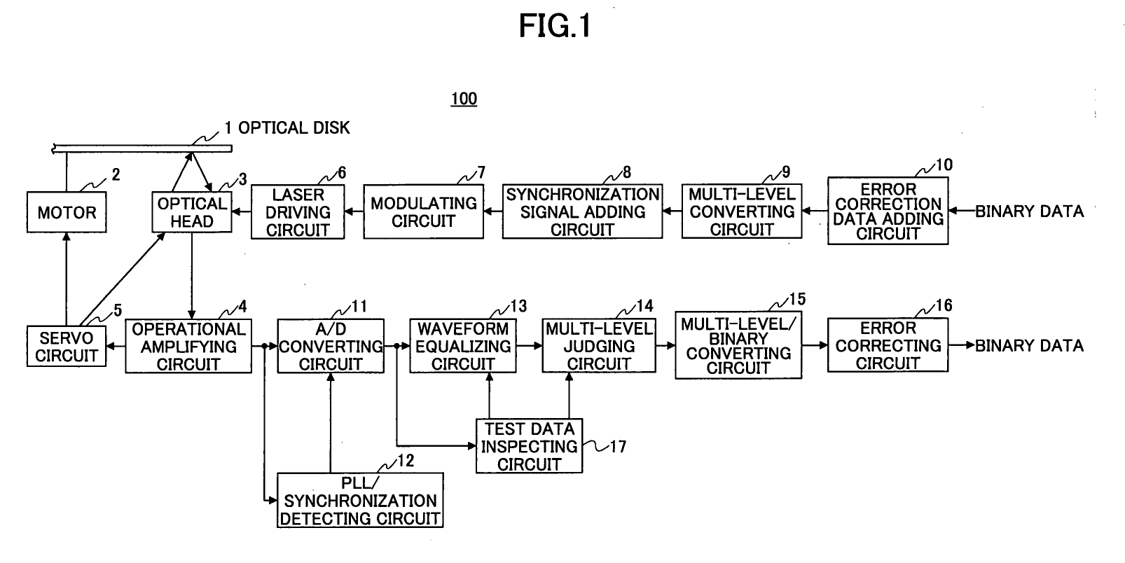

FIG. 1 is a block diagram showing a structure of an information recording/reproducing apparatus according to an embodiment of the present invention.

The information recording/reproducing apparatus 100 includes: an optical disk 1 on which marks are recorded to spiral or concentric tracks thereof; a motor 2 which rotates the optical disk 1; an optical head 3 irradiating a spot of laser light on the optical disk 1 for recording marks thereto and scanning the marks with the spot of laser light for outputting electric signals; an operation amplifying circuit 4 which subjects the electric signals outputted from the optical head 3 to an operational amplification, so as to thereby output reproduction signals corresponding to the marks on the optical disk 1, focus error signals for indicating a focus state of the spot of laser light with respect to a recording surface of the optical disk 1, tracking error signals for indicating a tracking state of the spot of laser light with respect to the tracks of the optical disk 1, and/or signals corresponding to meandering movements of the tracks; a servo circuit 5, in accordance with the foregoing signals, matching the focus of the spot of laser light on the recording surface of the optical disk 1, enabling the tracks to be scanned appropriately, and/or allowing the optical disk 1 to be rotated at a steady linear or angular rate in accordance with the signals; a modulating circuit 7 outputting signals which indicate sizes of the marks corresponding to inputted multi-level data and blank spaces (spaces, at which no information is recorded, correspond to zero data of multi-level data); a laser drive circuit 6 outputting signals for recording the marks on the optical disk 1 in accordance with the signals outputted from the modulating circuit 7; a synchronization signal adding circuit 8 adding synchronization signals for indicating sections of prescribed amounts of data; a multi-level converting circuit 9 for converting inputted binary data into multi-level data; an error correction data adding circuit 10 for adding error correction data; an A/D converting circuit 11 for converting reproduction signals from the operational amplifying circuit 4 into digital signals; a PLL/synchronization detection circuit 12 for outputting clock signals synchronizing with the multi-level data; a waveform equalizing circuit 13 for equalizing a waveform; a multi-level judging circuit 14 for judging the multi-level data; a multi-level/binary converting circuit 15 for converting multi-level data into binary data; an error correction circuit 16 for correcting errors in accordance with the error correction data; and a test data inspection circuit 17 for inspecting abnormalities in the test data on the optical disk 1.

Although not illustrated in FIG. 1, the information recording/reproducing apparatus 100 also includes a searching unit which moves the optical head 3 in a radial direction of the optical disk 1 to thereby search data on the optical disk 1. Furthermore, illustrations of, for example, an interface circuit to be used as an information memory apparatus for a computer, and/or a microprocessor for controlling an entire operation of the information recording/reproducing apparatus have been omitted.

An operation of the information recording/reproducing apparatus according to an embodiment of the present invention is hereinafter described.

First, an operation of converting binary data into multi-level data and then recording information to the optical disk 1 is hereinafter described.

Binary data, being inputted to the information recording/reproducing apparatus 100, is divided into blocks with prescribed amounts of data. Then, the error correction data adding circuit 10 adds error correction data to the input binary data. Then, the multi-level converting circuit 9 converts the input binary data into multi-level data. In the multi-level converting circuit 9 (described in greater detail below), for example, distinction data is added by inserting one test frame for every one hundred data frames. Then, the synchronization signal adding circuit 8 adds a synchronization signal and a clock mark to each of the data frames. Then, the modulating circuit 7 generates signals for driving the laser light in order to record marks corresponding to each of the values of the multilevel data onto the optical disk 1′. Then, the optical head 3 records the marks on the optical disk 1.

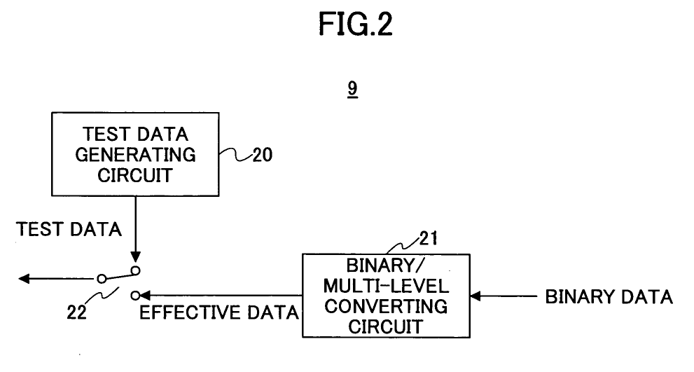

FIG. 2 is a view showing an internal structure of the multi-level converting circuit 9 according to an embodiment of the present invention. The multi-level converting circuit 9 inserts test data, which is the output of a test data generating circuit, at a prescribed interval by using a switch 22 that switches the output of the test data generating circuit 20 and the output of a binary/multi-level converting circuit 21. The multi-level data outputted from the binary/multi-level converting circuit 21 is hereinafter referred to as “effective data”. In this embodiment, eight value data (0 to 7) are used as multi-level data. With this embodiment, test data, which has every three (digit) consecutive data combination of multi-level data recorded therein, is reproduced, and then, a table for pattern recognition is generated according to the test data. In executing detection of multi-level data, three consecutive data is input, and then, multi-level data is detected by searching through the table for a pattern which is similar to and/or most similar to a pattern of the input three consecutive data.

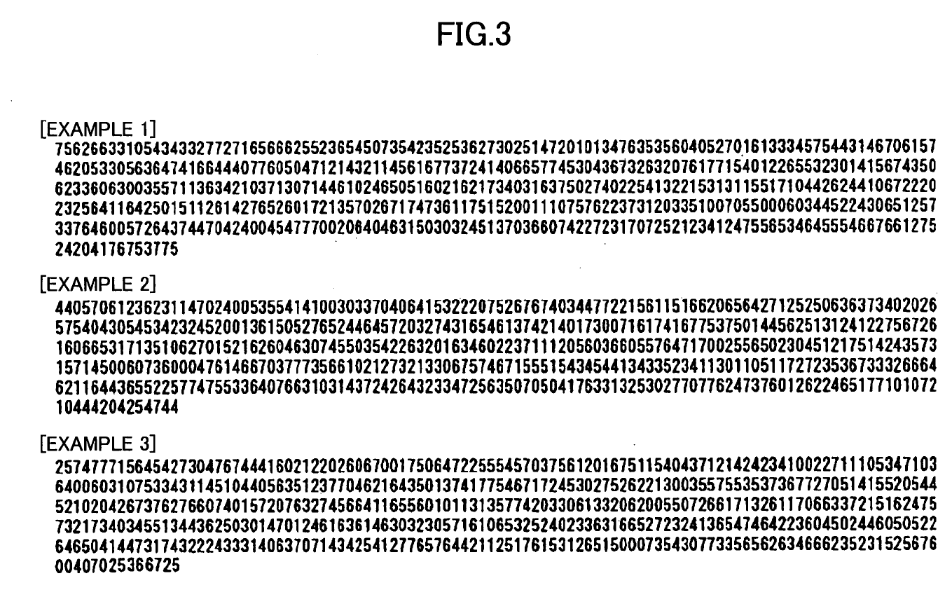

FIG. 3 shows three examples of test data. The numeric series of the test data is a random numeric series comprising 514 digits of data. Beginning from the first three digit consecutive data of the numeric series (e.g. “756” in Example 1), a three digit consecutive data may be considered to one combination (data pattern). By shifting one digit each, 512 combinations can be formed, where each combination is always different from the other combination (in Example 1, the second combination would be 562, the third would be 626, the fourth would be 266, and the fifth would be 663). That is, no combination is used repeatedly.

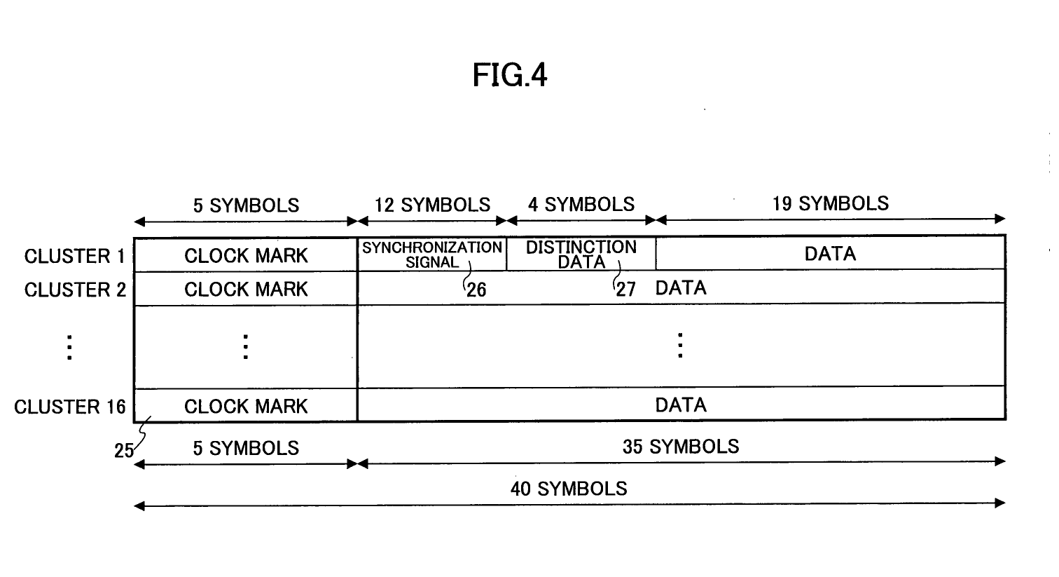

FIG. 4 is a diagram showing an example of a data format that allocates test data and effective data. Here, a single multi-level data is referred to as a “symbol”. In FIG. 4, the alignment of symbols (multi-level data) is referred to as a “frame”. The frame including test data is referred to herein as a “test frame”, and effective data referred to herein as a “data frame”.

Examples of other data patterns corresponding to a clock mark 25, a synchronization signal 26, and a distinction data 27 shown in FIG. 4 are further described below.

Clock mark=“00700”

Synchronization signal=“000007777777”

Distinction data=“0000” (Test frame)

“0077” (Data frame)

FIG. 5 shows an example of reproduction signals in a case where the clock mark 25, the synchronization signal 26, and the distinction data 27 are recorded to the optical disk 1. The clock mark 25 is data serving to indicate a basing point when sampling multi-level data, in which a bottom point of signal “7” arranged at the center of the clock mark 25 is a basing point. Multi-level data between clock marks may be sampled in the PLL circuit by generating clocks synchronizing with the bottom point of the clock marks that appear periodically. The sampling may also be performed by converting the reproduction signals from analog to digital, and detecting the bottom point for two consecutive clock marks to thereby sample the multilevel data therebetween in evenly spaced intervals. Here, a single segment of data comprising 40 symbols starting from the clock mark 25 is referred to as a “cluster”. Furthermore, judgment of whether the data in the frame is test data or effective data is performed by referring to the distinction data 27. The net amount of data excluding the clock mark, the synchronization signal, the distinction signal in the frame is expressed with the equation below.

19 symbols+35 symbols×15 clusters=544 symbols

Since a single symbol takes 8 values, a single symbol is the equivalent of 3 bits. Accordingly, in expressing the net amount of data by bits, the net amount of data would be 1632 bits (544 symbols×3 bits). In expressing the net amount of data by bytes, the net amount of data would be 204 bytes (1632 bits/8 bits).

514 symbols of test data are allocated in a test frame. When a test frame is divided by insertion of the clock mark 25, two symbols are required to be repeated after the division, since a data pattern of three digits is required. Therefore, with respect to clusters 2 through 16, two symbols are subtracted from the frame data, to thereby result to the below given equation.

19 symbols+(35−2) symbols×15 clusters=514 symbols

Accordingly, 514 symbols of test data can be efficiently allocated in a test frame, and thus 204 bytes of effective data can be allocated in a data frame.

Next, a procedure of executing multi-level judgment by reading out signals (i.e. multi-level signals corresponding to multi-level data) from the optical disk 1, and outputting binary data is described. First, a laser light of a prescribed intensity is irradiated upon the optical disk 1. The light reflected from the optical disk 1 is subject to photo-electric conversion, to thereby obtain electric signals. The obtained electric signals are input to the operational amplifying circuit 4. According to the output from the operational amplifying circuit 4, the servo circuit 5 steadily rotates the optical disk 1 and controls tracking and focusing of the optical head 3. Thereby, multi-level signals are reproduced. Synchronization signals and clock marks are detected from the reproduced multi-level signals to thereby allow the PLL circuit to generate a clock synchronizing with the multi-level data. Digital data is obtained in the A/D conversion circuit with use of the generated clock.

In the test data inspection circuit 17, distinction data (i.e. test data or effective data) for each frame is read out from the digital data. If the input digital data is a test frame (i.e. test data), the waveform equalization circuit 13 and the multi-level judging circuit 14 are stopped to thereby perform inspection of test data.

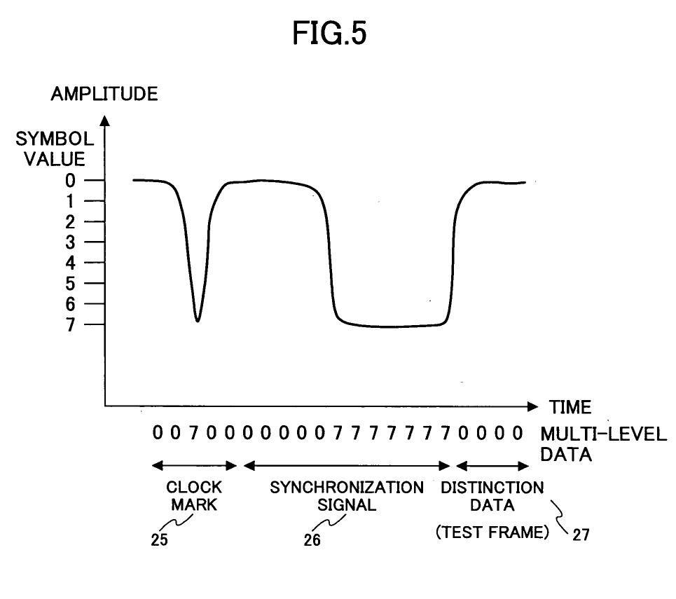

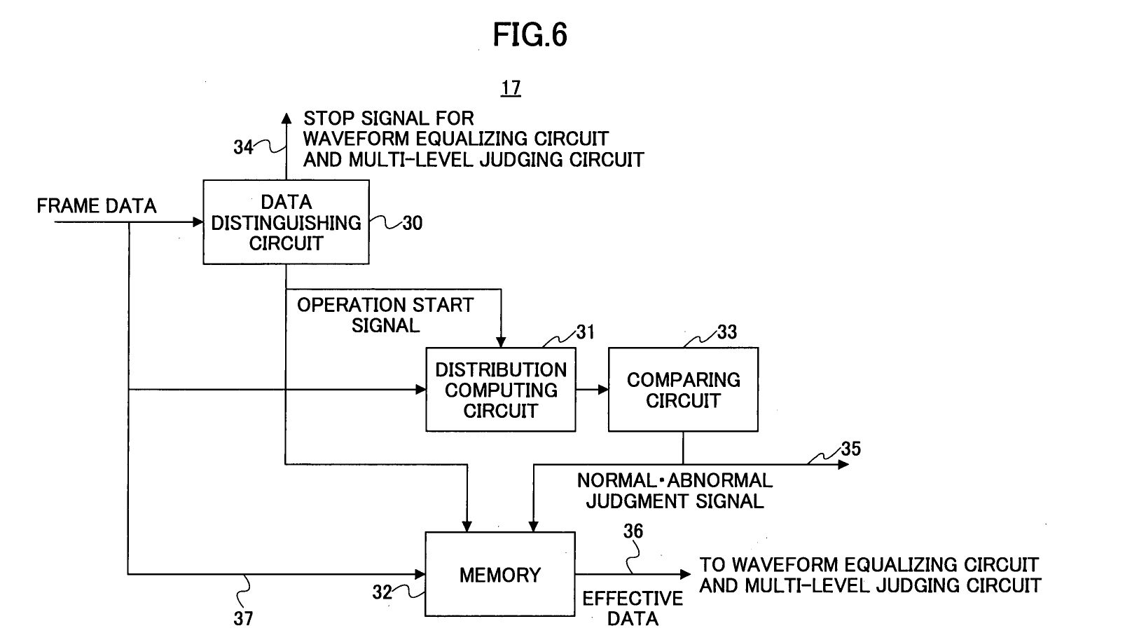

FIG. 6 is a diagram showing a structure of the test data inspecting circuit 17. A data distinguishing circuit 30 serves to distinguish distinction data in the frames. In a case where the digital data is test data, a stop signal 34 for stopping the operation of the waveform equalizing circuit 13 and the multi-level judging circuit 14 is output. Furthermore, a distribution computation circuit 31 computes the frequency distribution of the input data (digital signal value of the multi-level data). At the same time, signal values of test data (frame data) 37 are input to a memory 32. If a comparison circuit 33 determines that the test data is normal, the comparison circuit 33 outputs a signal 35 to the memory 32 so that data in the memory 32 (effective data 36) is output to the waveform equalizing circuit 13. Then, the waveform equalizing circuit 13 executes waveform equalization by deciding a coefficient for a waveform equalization filter according to an automatic equalization algorithm. Furthermore, the memory 32 also outputs data to the multi-level judging circuit 14 to thereby create a pattern table 47 (described below) for performing pattern recognition.

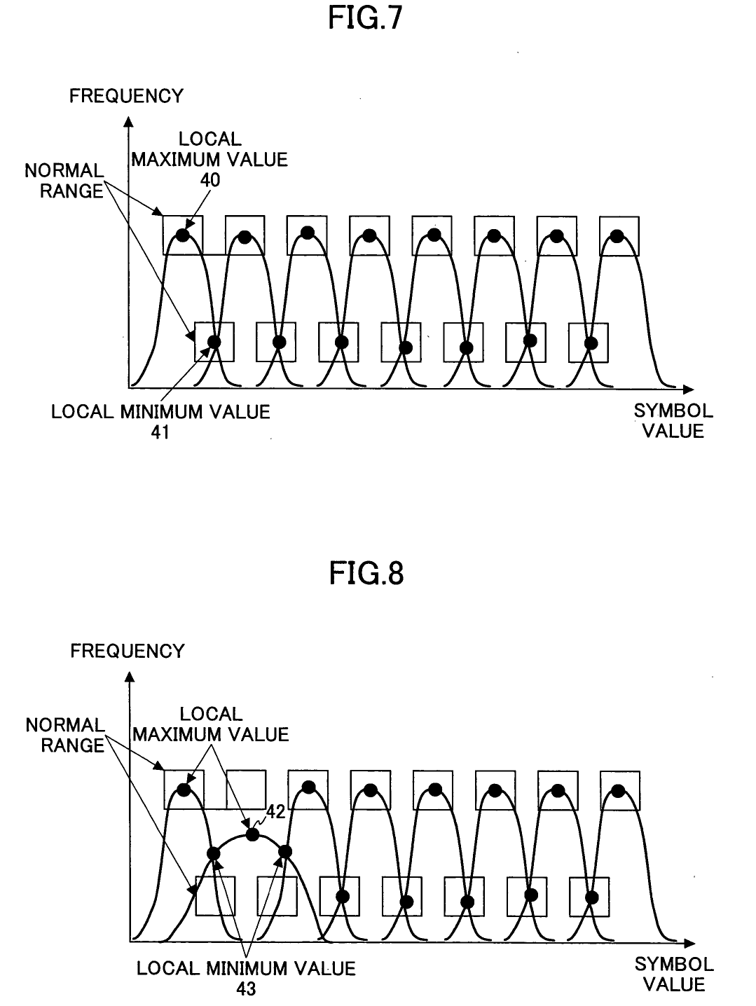

FIG. 7 is a diagram showing an example of a distribution of test data signals. With reference to FIG. 7, each symbol value (0 through 7) of the multilevel data is distributed in a divided manner, in which the test data is determined to be normal when each maximum value 40 and minimum value 41 in the distribution falls within a prescribed range (inside the rectangular shape in FIG. 7). For example, in a distribution shown in FIG. 8, the test data is determined to be abnormal due to the fact that a maximum value 42 and a minimum value 43 for symbol value 0 and 1 are outside of the rectangular shape, respectively.

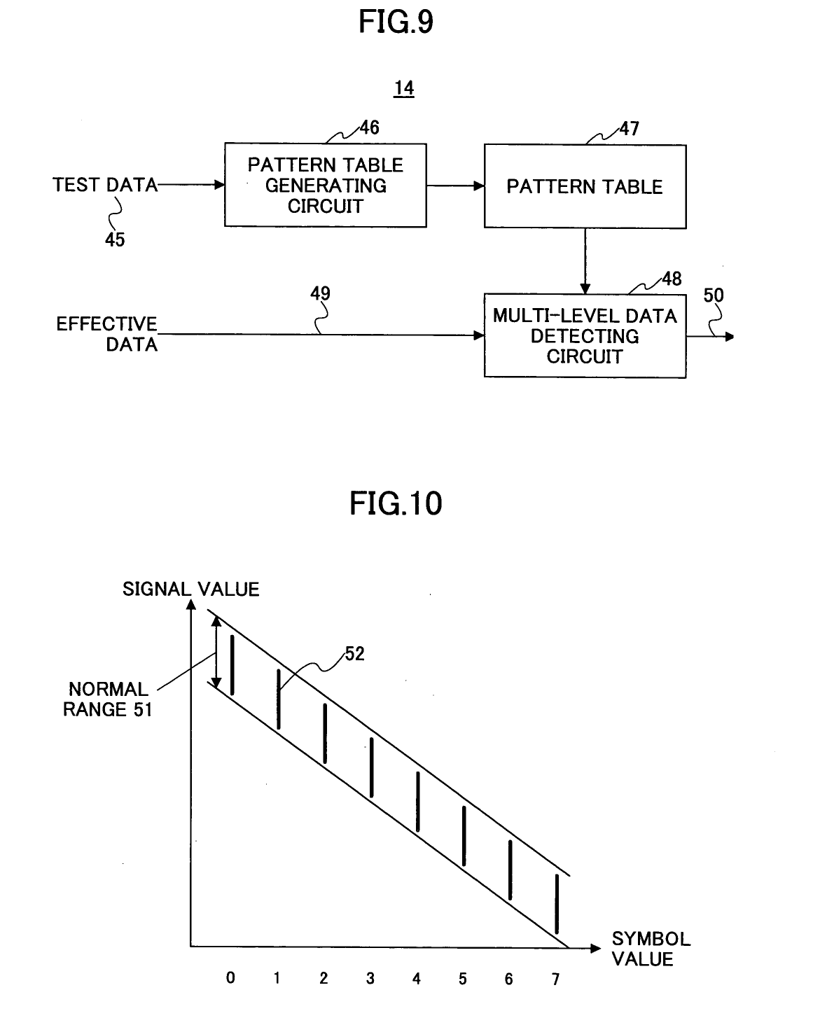

FIG. 9 is a diagram showing an internal structure of the multi-level judging circuit 14. The multi-level judging circuit 14 includes a pattern table generating circuit 46 to which test data is input and a multi-level data detecting circuit 48, wherein the table generating circuit 46 creates a pattern table 47, and the multi-level data detecting circuit 48 detects multilevel data by pattern recognition. When test data 45 on the optical disk 1 is reproduced and determined to be normal by the test data inspecting circuit 17, the effective data of the data frame on the optical disk 1 is input to the waveform equalizing circuit 13 after the coefficient of the filter in the waveform equalizing circuit 13 is decided according to an automatic equalization algorithm and thus after the generating of the pattern table 47. Then, the output from the waveform equalizing circuit 13 is input to the multilevel judging circuit 14. The multi-level data detecting circuit 48 inside the multi-level judging circuit 14 outputs the effective data 49 as multi-level data 50. Subsequently, a multi-level/binary converting circuit 15 converts the multi-level data 50 into binary data. Then, after the binary data is subject to error detection and error correction by an error correction circuit 16, the binary data is output.

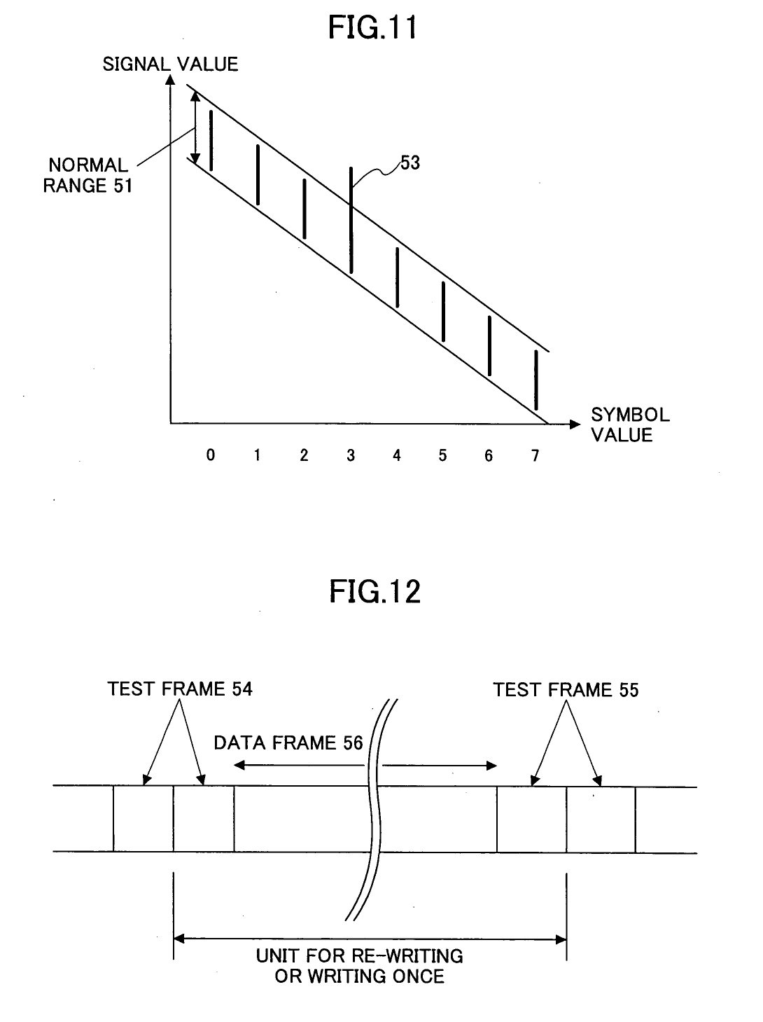

In determining whether the test data is normal, the foregoing embodiment refers to the highest peak value and lowest peak value of the distribution of signal values, owing that the highest peak value and lowest peak value serve to indicate feature amounts of the distribution of signal values. In another embodiment, the test data may be determined by referring to a distribution range of a signal value 52 with respect to a symbol value of test data (see FIG. 10). With reference to FIG. 10, test data is determined to be normal if the computed distribution range of a signal value 52 is included within a range 51 restricted by two lines illustrated in FIG. 10. On the other hand, test data is determined to be abnormal if the computed distribution range of a signal value 52 surpasses the range 51 as in a manner illustrated with numeral 53 in FIG. 11. In this embodiment, the maximum and minimal values of each symbol value of test data are compared with the values indicated by the two lines, in which the maximum and minimal values of the distribution of signal values serve to indicate feature amounts of the signal values.

In the foregoing embodiments, test data is not used again if the test data is determined to be abnormal. However, even in a case where the test data is determined to be abnormal, the same test data, for example, may be read out for a second time from the optical disk 1. In a case where the test data read out for the second time is determined to be normal, the cause for the abnormality could be a contingent noise rather than a defect in the optical disk 1. In a case where the test data read out for the second time determined to be abnormal again, the optical disk 1 is likely to have a critical defect, and the test data on the optical disk 1 would, therefore, not be used.

In the foregoing embodiments where 1 test frame is inserted between each data frame comprising 100 frames, the data frame comprising 100 frames may be processed with respect to 1 test frame. That is, the data frame comprising 100 frames may be processed by executing the procedures of inspecting test data, deciding the coefficient for waveform equalization, and generating the pattern table with respect to 1 test frame.

In another embodiment, for example, 10 test frames may be inspected, and those that are determined to be abnormal are eliminated. Then, the average value of the signal values of test data are obtained, to thereby determine the coefficient for waveform equalization and generate the pattern table. Subsequently, the data frames (900 frames) allocated between the 10 test frames may be processed. This provides an advantage of reducing multi-level detection error in a case where reproduction signals for the entire optical disk 1 are in a steady state.

In another embodiment, the procedures of determining the coefficient for waveform equalization and generating the pattern table may be executed with respect to the average value of 2 test frames of normal test data, to thereby process the data frames allocated between the test frames. This is advantageous in a case where patterns in the changes of signals vary according to the area of the optical disk 1.

The information recording/reproducing apparatus 1 may, for example, re-write data on the optical disk 1 where the optical disk 1 is a re-writable optical disk. The information recording/reproducing apparatus 1 may also, for example, write once on the optical disk 1 where the optical disk 1 is a write-once optical disk (a disk of which data can neither be erased or re-written). In any case, recording conditions (e.g. amount of laser light) are relatively uniform when data is re-written or written once on the same disk with a same information recording/reproducing apparatus (optical disk apparatus), and thus changes in reproduction signals are relatively small. Meanwhile, reproduction signals may change rather considerably where data is re-written or written once on a same disk with a different information recording/reproducing apparatus (optical disk apparatus). Therefore, in a case, for example, where a data frame 56 is targeted to have data re-written or written-once thereto, it is preferable to dispose test frames 54 and 55 in front of and in back of the data frame 56. It is to be noted that a test frame may be disposed in the center of a data frame that is targeted to have data re-written or written-once thereto. This enables more adaptability to changes of reproduction signals owing to the characteristics of each information recording/reproducing apparatus, and reduces multi-level data detection errors.

Although the test frame in the above description includes merely 1 test data (1 series: 514 symbols) shown in FIG. 3, more amounts of data may be included in 1 frame, and plural test data of the same series may be included in the test frame. Accordingly, even in a case where there is an abnormality in one of the series of test data, another series of test data may be employed, to thereby enhance the reliability of data. Furthermore, in a case where plural test data in a single test frame are normal, reproduction signals could be restrained from changing by using the average value of the plural test data. In addition, although the above described case is a case where plural test data of the same series are included in a single frame, plural test data of different series may also be included in a single frame. This increases the randomness of the test data. By using the average value of the plural test data of different series, signals can be further restrained from changing. Although the above described embodiment is a case where data is processed by reading 1 test frame each time, the same test frame may be read several times so as to process data by using the average value of the test frames. Accordingly, random changes owing to factors such as noise can be reduced, to thereby reduce multi-level detection errors.

Further, the present invention is not limited to these embodiments, but various variations and modifications may be made without departing from the scope of the present invention.

The present application is based on Japanese priority application No. 2002-338342 filed on Nov. 21, 2002, with the Japanese Patent Office, the entire contents of which are hereby incorporated by reference.

What is claimed is:

1. An information recording/reproducing apparatus, comprising:
a binary/multi-level data converting unit converting binary data into multi-level data;
a test data generating unit generating test data forming part of the multi-level data;
a data recording unit recording the multilevel data including the test data to an information recording medium;
a signal reproducing unit outputting reproduction signals of the multi-level data including the test data from the information recording medium;
a test data examining unit examining the reproduction signals of the multi-level data including the test data to determine whether the test data is normal;
a waveform equalization unit equalizing a waveform of the examined test data when the test data examining unit determines that the test data is normal; and
a multi-level determining unit determining multi-level data by referring to a pattern table generated using the examined test data.

2. The information recording/reproducing apparatus as claimed in claim 1, wherein the test data examining unit includes:
a data distinguishing unit categorizing an input data frame into a test frame including the test data and a data frame;
a distribution computing unit computing a frequency distribution of values for the reproduction signals of the test data;
a feature amount detection unit detecting a feature amount of the computed frequency distribution;
a comparing unit deciding whether the test data is normal by comparing the detected feature amount with a prescribed value; and
a memory unit storing the values of the reproduction signals of the test data.

3. The information recording/reproducing apparatus as claimed in claim 2, wherein when the data distinguishing unit determines that the input data frame is the test frame, the waveform equalizing unit and the multi-level determining unit stop operating, the distribution computing unit starts computing the frequency distribution of the values for the reproduction signals of the test data, and the memory unit stores the test data.

4. The information recording/reproducing apparatus as claimed in claim 2, wherein when the comparing unit decides that the test data is normal, effective data in the memory unit is output to the waveform equalization unit for determining a coefficient of a filter of the waveform equalization unit according to automatic equalization algorithm, and the effective data is also output to the multi-level data determining unit for generating the pattern table.

5. The information recording/reproducing apparatus as claimed in claim 1, wherein the multi-level data determining unit includes:
a pattern table generating unit generating the pattern table; and
a multi-level data detecting unit detecting the multi-level data by searching through the pattern table for a pattern which is similar to effective data in the memory unit.

6. The information recording/reproducing apparatus as claimed in claim 5, wherein when the test data examining unit determines that the test data is normal, the multi-level data detecting unit outputs the effective data in the memory unit as multi-level data.

7. The information recording/reproducing apparatus as claimed in claim 2, wherein when the comparing unit decides that the test data is abnormal, the test data from the information recording medium is examined again and input to the distribution computing unit.

8. The information recording/reproducing apparatus as claimed in claim 7, wherein the test data is not used when the test data is again decided to be abnormal.

9. The information recording/reproducing apparatus as claimed in claim 2, wherein one or more test data from the information recording medium is examined, wherein when the feature amount of the test data surpasses a prescribed range, the value of the reproduction signals of the test data surpassing the prescribed range is excluded, wherein an average of the values of the reproduction signals of the test data except for the excluded test data is obtained for detecting the multi-level data.

10. The information recording/reproducing apparatus as claimed in claim 9, wherein the test data is allocated before and after the multi-level data.

11. The information recording/reproducing apparatus as claimed in claim 1, wherein the test data includes combinations of data comprising same numeric series.

12. The information recording/reproducing apparatus as claimed in claim 1, wherein the test data includes combinations of data comprising different numeric series.

13. An information recording/reproducing apparatus for reproducing multi-level data based on examined test data, wherein multi-level data is converted from binary data, test data is generated as part of multi-level data, and reproduction signals of the multi-level data including the test data are reproduced as reproduction signals including the test data, the information recording/reproducing apparatus comprising:
a test data examining unit examining the reproduction signals of the multi-level data including the test data to determine whether the test data is normal;
a waveform equalization unit equalizing a waveform of the examined test data when the test data examining unit determines that the test data is normal; and
a multi-level determining unit determining multi-level data by referring to a pattern table generated using the examined test data.

14. An information recording medium comprising:
multi-level data converted from binary data; and
test data used in reproducing the multi-level data,
wherein the test data includes combinations of data comprising same numeric series.

15. An information recording medium comprising:
multi-level data converted from binary data; and
test data used in reproducing the multi-level data,
wherein the test data includes combinations of data comprising different numeric series.
